(19) United States
(12) Patent Application Publication
(10) Pub. No.: US 2011/0161323 A1
(43) Pub. Date: Jun. 30, 2011

(54) Information Processing Device, Method of Evaluating Degree of Association, and Program

(76) Inventor: Takehiro HAGIWARA, Tokyo (JP)

(21) Appl. No.: 12/959,988

(22) Filed: Dec. 3, 2010

(30) Foreign Application Priority Data
Dec. 25, 2009 (JP) P2009-296065

(51) Int. Cl. G06F 17/30

(52) U.S. Cl. 707/737; 707/E17.089

(57) ABSTRACT

There is provided an information processing device including: a storage unit that stores information element data defining a plurality of information elements; an information acquisition unit that acquires an information set having a referential relationship with each other from an information source accessible through a communication network; a classification unit that classifies information included in the information set acquired by the information acquisition unit into information of a first class corresponding to an information element defined by the information element data and information of a second class other than the information of the first class; and an evaluation unit that evaluates a degree of association between information elements respectively corresponding to two or more information of the first class based on a referential relationship between the information of the first class and the information of the second class in the information set.

### BACKGROUND OF THE INVENTION

1. Field of the Invention

The present invention relates to an information processing device, a method of evaluating a degree of association, and a program.

2. Description of the Related Art

With the recent development of information and communications technology, various kinds of information such as music, video, electronic book, news article, product information or event information are provided to a user through a network. One of typical techniques for an individual user to find information suitable for the user from such enormous information is a technique that a user makes search by him/herself and another is a technique that a system recommends appropriate information for a user.

One technique for a user to make search by him/herself is a keyword search. However, the keyword search has a drawback that a inputting keyword is troublesome for a user who operates a terminal device without a keyboard. Further, in the case of the keyword search, because a keyword that comes to a user's mind is used for a search, the possibility that the user finds useful information or unexpected novel information is low. Another technique for a user to make search by him/herself is a genre search. In the case of the genre search, a search is made by sequentially selecting predefined hierarchical genres. However, it is not easy to artificially assign adequate genres to various kinds of information existing on the network.

In the technique that a system recommends information suitable for a user, which is a technique called recommendation, in many cases, a preference of a user is defined as a score according to a user's action such as viewing of information or purchase of a content, and information suitable for the preference of the user is recommended. For example, Japanese Unexamined Patent Publications Nos. 2004-355340 and 2006-251866 propose not only recommending a content suitable for a user preference but also presenting a reason for the recommendation to a user.

### SUMMARY OF THE INVENTION

Generally, there is a huge variety of viewpoints to associate information with information. Therefore, it is not easy to assign a limited kind of genres to a huge kind of information so as to satisfy many users. Further, in the case of making recommendation on the basis of a user preference which is defined as a score in a fixed vector space, because information to be recommended is selected only from the viewpoint that corresponds to the vector space, it is likely that only information within expectation (not novel) of a user is recommended. Further, daring to recommend information beyond expectation to a user raises an issue that it is difficult to convince the user why the information is recommended.

On the other hand, if it is realized to flexibly extract a variety of viewpoints to associate information with information and utilize the extracted viewpoints for information search by a user or recommendation, it will be able to navigate a user to surprising information and sufficiently convince the user.

In light of the foregoing, it is desirable to provide a novel and improved information processing device, method of evaluating a degree of association and program which can extract a variety of viewpoints to associate information with information and utilize the viewpoints for information search or recommendation.

According to an embodiment of the present invention, there is provided an information processing device including: a storage unit that stores information element data defining a plurality of information elements; an information acquisition unit that acquires an information set having a referential relationship with each other from an information source accessible through a communication network; a classification unit that classifies information included in the information set acquired by the information acquisition unit into information of a first class corresponding to an information element defined by the information element data and information of a second class other than the information of the first class; and an evaluation unit that evaluates a degree of association between information elements respectively corresponding to two or more information of the first class based on a referential relationship between the information of the first class and the information of the second class in the information set.

In this configuration, information of the first class and information of the second class are acquired from the information source accessible through the communication network. The information of the first class corresponds to information elements defined by the information element data. The information element data may define each information to be used for information search or recommendation, for example. Further, the information of the second class is treated as information representing a viewpoint that is likely to connect two or more information elements. Based on a referential relationship between the information of the first class and the information of the second class, the evaluation unit evaluates a degree of association between two or more information elements which can be used for various purposes such as information search or recommendation.

The evaluation unit may further determine a type of association between the information elements respectively corresponding to two or more information of the first class based on the referential relationship between the information of the first class and the information of the second class in the information set.

The evaluation unit may count at least one of the number of references from the information of the first class to the information of the second class and the number of references from the information of the second class to the information of the first class with respect to each information in the information set, and calculate the degree of association between the information elements respectively corresponding to two or more information of the first class referring to common information of the second class or referred to from common information of the second class based on the number of references counted for the common second class.

The evaluation unit may determine a type of association between the information elements respectively corresponding to the two or more information of the first class from the common information of the second class.

The information processing device may further include: a screen control unit that outputs an information element display screen displaying two information elements associated with each other in a result of evaluation by the evaluation unit so as to be adjacent to each other.

The information element display screen may be a screen where, in a state where one information element is selected, another information element displayed adjacent to the selected information element is selectable by a user.

The screen control unit may sequentially arrange information elements selected by a user in a first direction and arranges a plurality of information elements associated with an information element selected most recently by a user in a second direction different from the first direction on the information element display screen, and each information element arranged in the second direction may be selectable by a user.

The screen control unit may display, in close proximity to the two information elements displayed adjacent to each other, a type of association between the two information elements on the information element display screen.

The screen control unit may only display information elements belonging to a given category among information elements having a certain degree of association in a result of evaluation by the evaluation unit on the information element display screen.

The information processing device may further include: a recommendation unit that, when a first content and a second content are viewed by a user, recommends another content selected according to a type of association between information elements corresponding to the first content and the second content to the user.

The information processing device may further include: an analysis unit that, when a series of information elements are viewed by a user, determines a preference of the user by using a degree of association between information elements associated with each other included in the series of information elements. The information processing device may further include: a recommendation unit that recommends a content selected based on a preference of a user determined by the analysis unit to the user.

The information processing device may further include: a recommendation unit that recommends a content selected based on an information element viewed by a user to the user and presents a reason for recommendation of the content to the user according to a type of association between an information element corresponding to the content and an information element as a basis of selection of the content.

The information processing device may further include: a recommendation unit that recommends a content selected according to an action history of a user from contents having an attribute corresponding to one or more information element among the plurality of information elements to the user and presents a reason for recommendation of the selected content to the user according to a type of association between an information element corresponding to an attribute of the selected content and another information element.

Such another information element is an information element corresponding to an attribute of another content as a basis of selection of the content.

Such another information element is an information element corresponding to an attribute of a user preference of the user.

The plurality of information elements defined by the information element data may include an information element corresponding to a music content, and the information processing device may further include a playing unit that sequentially plays music contents corresponding to information elements associated with each other in a result of evaluation by the evaluation unit.

According to another embodiment of the present invention, there is provided a method of evaluating a degree of association between information elements by using an information processing device including a storage unit that stores information element data defining a plurality of information elements, the method including the steps of: acquiring an information set having a referential relationship with each other from an information source accessible through a communication network; classifying information included in the information set acquired from the information source into information of a first class corresponding to an information element defined by the information element data and information of a second class other than the information of the first class; and evaluating a degree of association between information elements respectively corresponding to two or more information of the first class based on a referential relationship between the information of the first class and the information of the second class in the information set.

According to another embodiment of the present invention, there is provided a program causing a computer controlling an information processing device including a storage unit that stores information element data defining a plurality of information elements to function as a device including: an information acquisition unit that acquires an information set having a referential relationship with each other from an information source accessible through a communication network; a classification unit that classifies information included in the information set acquired by the information acquisition unit into information of a first class corresponding to an information element defined by the information element data and information of a second class other than the information of the first class; and an evaluation unit that evaluates a degree of association between information elements respectively corresponding to two or more information of the first class based on a referential relationship between the information of the first class and the information of the second class in the information set.

According to the embodiment of the present invention described above, it is possible to provide an information processing device, a method of evaluating a degree of association and a program which can extract a variety of viewpoints to associate information with information and utilize the viewpoints for information search or recommendation.

### BRIEF DESCRIPTION OF THE DRAWINGS

FIG. 1 is a schematic view showing an overview of an information processing device according to one embodiment.

FIG. 2 is a block diagram showing an example of a configuration of an information processing device according to one embodiment.

FIG. 3 is an explanatory view showing an example of information element data according to one embodiment.

FIG. 4A is an explanatory view to explain an example of classification of information by a classification unit according to one embodiment.

FIG. 4B is an explanatory view to explain another example of classification of information by a classification unit according to one embodiment.

FIG. 5 is an explanatory view to explain a basic rule for counting of the number of references according to one embodiment.

FIG. 6A is an explanatory view showing an example of data related to the number of references to common information of an association class.

FIG. 6B is an explanatory view showing an example of data related to the number of references from common information of an association class.

FIG. 6C is an explanatory view to explain a first table that stores a counting result of the number of references according to the examples of data in FIGS. 6A and 6B.

FIG. 6D is an explanatory view to explain a second table that stores a counting result of the number of references according to the examples of data in FIGS. 6A and 6B.

FIG. 7 is an explanatory view to explain a third table that stores a counting result of the number of references to/from information of a node class.

FIG. 8 is an explanatory view showing an example of a degree of association between information elements for each information of an association class calculated based on a counting result of the number of references.

FIG. 9 is an explanatory view showing an example of a type of association between information elements that can be determined by an evaluation unit according to one embodiment.

FIG. 10 is an explanatory view showing an example of a degree of association between information elements that is calculated by an evaluation unit according to one embodiment.

FIG. 11 is an explanatory view showing an example of an information element display screen according to one embodiment.

FIG. 12A is an explanatory view to explain a change of the information element display screen shown in FIG. 11 according to a first user input.

FIG. 12B is an explanatory view to explain a change of the information element display screen shown in FIG. 11 according to a second user input.

FIG. 12C is an explanatory view to explain a change of the information element display screen shown in FIG. 11 according to a third user input.

FIG. 13 is an explanatory view to explain an example of a recommendation process by a recommendation unit according to one embodiment.

FIG. 14 is a first explanatory view to explain an example of a user preference analysis process by an analysis unit according to one embodiment.

FIG. 15 is a second explanatory view to explain an example of a user preference analysis process by an analysis unit according to one embodiment.

FIG. 16 is an explanatory view showing an example of a recommendation screen on which a reason for recommendation is presented by a recommendation unit according to one embodiment.

FIG. 17 is an explanatory view to explain a first alternative example of a process of determining a reason for recommendation by a recommendation unit according to one embodiment.

FIG. 18 is an explanatory view to explain a second alternative example of a process of determining a reason for recommendation by a recommendation unit according to one embodiment.

FIG. 19 is a block diagram showing an example of a configuration of an information processing device according to a first application example.

FIG. 20 is a block diagram showing an example of a configuration of an information processing device according to a second application example.

FIG. 21 is a block diagram showing an example of a configuration of a general-purpose computer.

### DETAILED DESCRIPTION OF THE EMBODIMENT(S)

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Preferred embodiments of the present invention will be described hereinafter in the following order:

1. Overview of Information Processing System

2. Exemplary Configuration of Information Processing Device According to Embodiment
2-1. Evaluation of Degree of Association
2-2. Navigation
2-3. Application to Recommendation

3. Other Application Examples
3-1. Playback of Music
3-2. Use of Positional Information

4. Hardware Configuration

5. Summary

### 1. Overview of Information Processing System

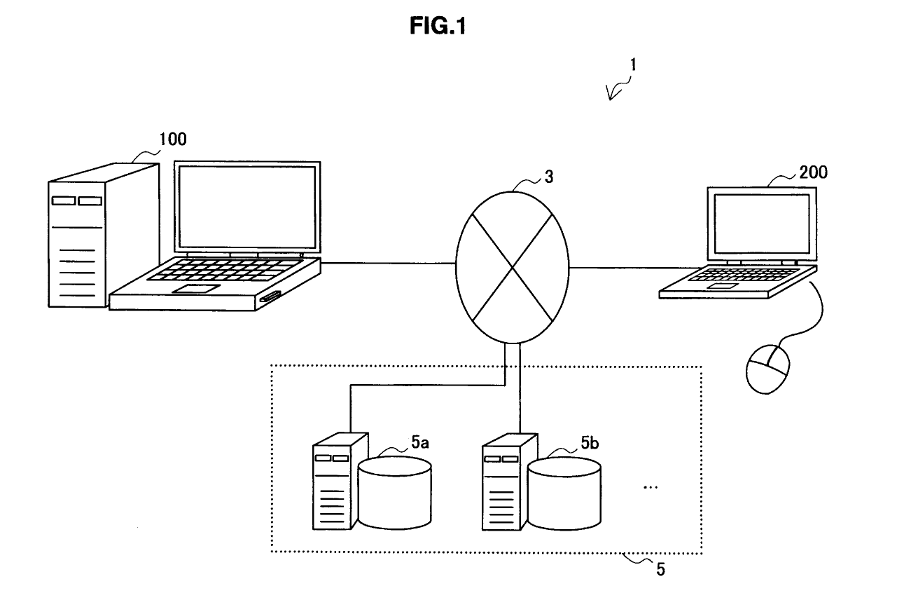

An information processing system to which one embodiment of the present invention can be applied is described hereinafter with reference to FIG. 1. FIG. 1 is a schematic view showing an overview of an information processing device 1 according to one embodiment of the present invention. Referring to FIG. 1, the information processing device 1 includes an information processing device 100 and a terminal device 200. The information processing device 100 is connected to the terminal device 200 through a communication network 3.

The communication network 3 is a communication network that connects between the information processing device 100 and the terminal device 200. The communication network 3 may be an arbitrary communication network such as the Internet, IP-VPN (Internet Protocol-Virtual Private Network), a leased line, LAN (Local Area Network) or WAN (Wide Area Network). The communication network 3 may be wired or wireless. Further, the information processing device 100 can access an information source 5 including one or more servers 5a, 5b and so on through the communication network 3.

The servers 5a and 5b are server devices that can be accessed from the information processing device 100 through the communication network 3. Each server may be a Web server that transmits a Web page in response to a request from the information processing device 100, for example. Alternatively, each server may be a content server, a database server, a log server or the like, for example.

The information processing device 100 is a device for acquiring an information set from the server 5a or 5b and evaluating a degree of association between information elements by using the information set. The information elements whose degree of association is evaluated by the information processing device 100 are defined depending on a purpose of a service provided by the information processing device 100. For example, when the purpose is to guide a television program by digital broadcasting, a program name, a cast name or the like may be defined as information elements. Further, when the purpose is to provide a music content, an artist name, a music title or the like may be defined as information elements. A set of information having a referential relationship with each other is selected as an information set that is used by the information processing device 100. For example, in a group of Web pages provided from a Web server, a referential relationship is given by a link between the Web pages. Further, in an EPG (Electronic Program Guide) provided from a content server, a referential relationship is given by a link between information representing a program guide, a cast, a genre or the like. Furthermore, in a service log of an EC (Electronic Commerce) site provided from a log server, a referential relationship is given between a user and product information by a viewing history of a user or the like. The information processing device 100 evaluates a degree of association between information elements based on such a referential relationship in the information set. Further, in this embodiment, the information processing device 100 provides GUI (Graphical User Interface) for a user to search information elements. The information processing device 100 may be a general-purpose computer as shown in FIG. 1, for example. Alternatively, the information processing device 100 may be a digital household appliance installed in a home network or the like, for example.

The terminal device 200 is a device that is operated by a user, and the terminal device 200 displays the GUI provided from the information processing device 100 on its display. Thus, a user can search information elements under support of navigation by the information processing device 100. Further, the terminal device 200 displays the information element recommended by the information processing device 100 on its display. The terminal device 200 may be an arbitrary terminal device such as a PC (Personal Computer), a cellular phone, a PDA (Personal Digital Assistants), or a game terminal, for example.

### 2. Exemplary Configuration of Information Processing Device According to Embodiment

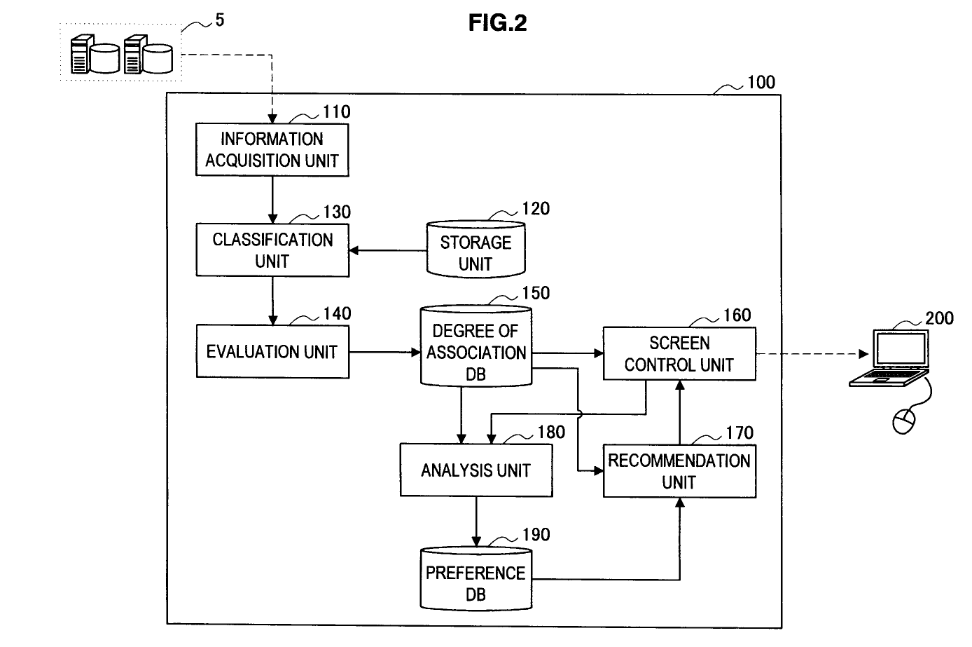

An example of a configuration of the information processing device 100 according to the embodiment is described hereinbelow. FIG. 2 is a block diagram showing an example of a configuration of the information processing device 100. Referring to FIG. 2, the information processing device 100 includes an information acquisition unit 110, a storage unit 120, a classification unit 130, an evaluation unit 140, a degree of association DB (database) 150, a screen control unit 160, a recommendation unit 170, an analysis unit 180, and a preference DB 190.

### [2-1. Evaluation of Degree of Association]

Among the component parts of the information processing device 100 shown in FIG. 2, the information acquisition unit 110, the storage unit 120, the classification unit 130 and the evaluation unit 140 are mainly involved in evaluation of a degree of association between information elements.

### (Information Acquisition Unit)

The information acquisition unit 110 acquires an information set having a referential relationship with each other from the information source 5 that is accessible through the communication network 3. The information set acquired by the information acquisition unit 110 may be a group of Web pages linked with each other, an EPG, a service log or the like as described above. The information acquisition unit 110 outputs the acquired information set to the classification unit 130.

### (Storage Unit)

The storage unit 120 previously stores information element data that defines a plurality of information elements by using a storage medium such as a hard disk or a semiconductor memory. The information element data defines a plurality of information elements according to the purpose of a service. For example, the information elements defined by the information element data can include a name of a person such as a cast name of a television program or an artist name associated with a music content, and a name of a content such as a program name of a television program or a music title.

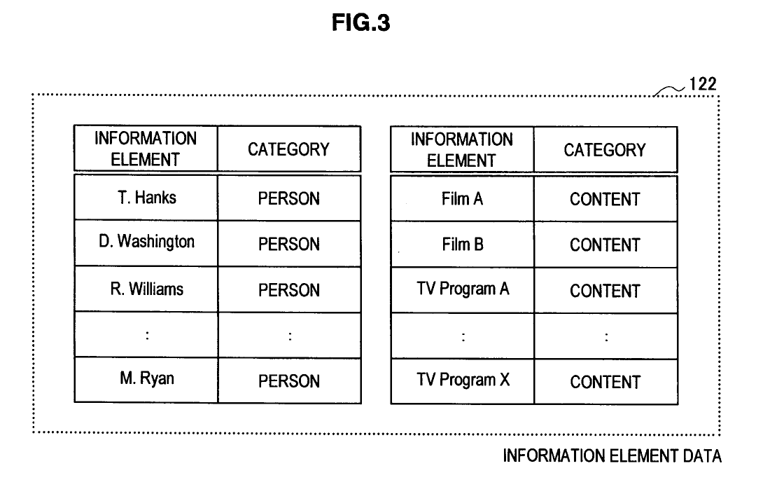

FIG. 3 is an explanatory view showing an example of the information element data stored in the storage unit 120 according to the embodiment. Referring to FIG. 3, information element data 122 having two data items “information element” and “category” is shown. The “information element” of the information element data 122 is a character string that represents each information element. The “category” indicates a type of each information element. In the example of FIG. 3, the information elements listed on the left belong to the category “person”. On the other hand, the information elements listed on the right belong to the category “content”. Thus, the information element data of this example involves a person master and a content master. The information element data is used for classification of information by the classification unit 130, which is described next. Further, the category of the information element can be used also for display of the information element on an information element display screen, which is described later.

### (Classification Unit)

The classification unit 130 classifies each information included in the information set acquired by the information acquisition unit 110 into information of a first class that corresponds to the information element defined by the information element data and information of a second class that is other than the information of the first class. In the following description, a first class is referred to as a node class, and a second class is referred to as an association class.

The node class is a class for information that corresponds to the information element defined by the information element data. For example, information that describes each person or each content which is defined by the information element data 122 illustrated in FIG. 3 can be the information of the node class. On the other hand, the association class is a class for information that is other than the information of the node class. Specifically, information that describes a matter other than the person and the content which are defined by the information element data 122 illustrated in FIG. 3 can be the information of the association class. The information of the association class has a referential relationship with the information of the node class and thereby represents association between information elements that respectively correspond to two or more information of the node class.

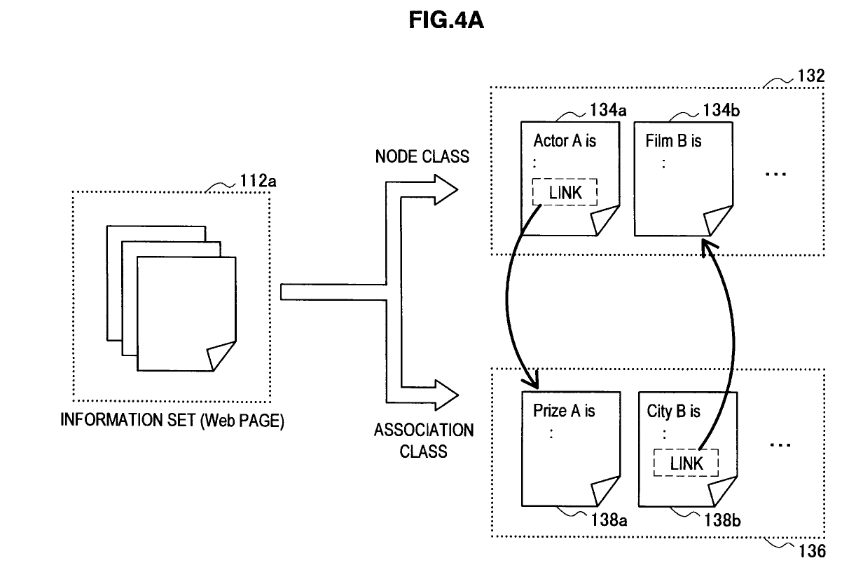

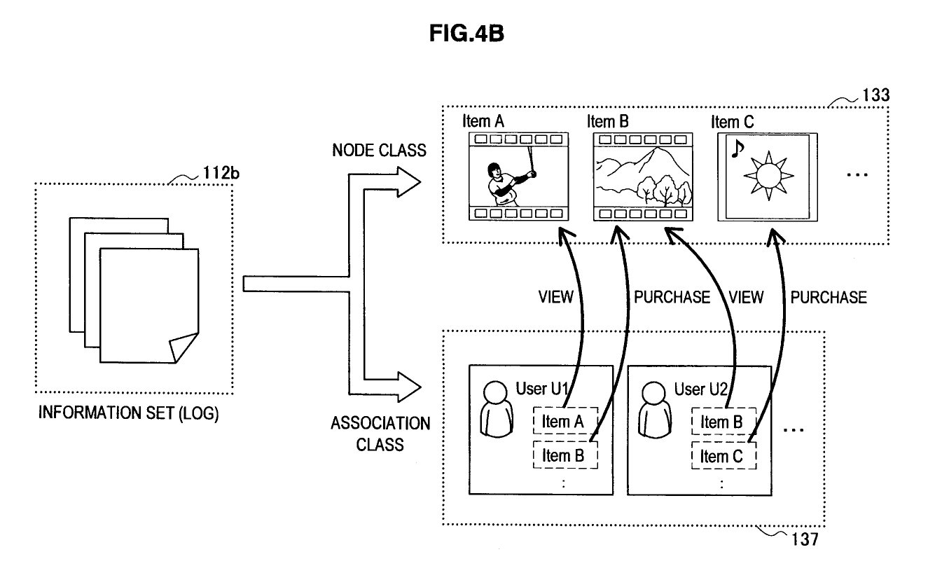

FIG. 4A is an explanatory view to explain an example of classification of information by the classification unit 130 according to the embodiment. On the left of FIG. 4A, an information set 112a including a group of Web pages acquired from a Web server by the information acquisition unit 110 is shown. For example, it is assumed that each Web page included in the information set 112a has a headline related to descriptions of the Web page. The classification unit 130 checks the headline of each Web page against the “information element” defined by the information element data and classifies a Web page with a headline matching the “information element” into the node class and a Web page with a headline not matching the “information element” into the association class. For example, referring to the right of FIG. 4A, a Web page 134a and a Web page 134b are classified into information 132 of the node class. The Web page 134a describes a person (“Actor A”). Further, the Web page 134b describes a content (“Film B”). Further, a Web page 138a and a Web page 138b are classified into information 136 of the association class. The Web page 138a describes a prize (“Prize A”). Further, the Web page 138b describes a city (“City B”). As described above, the information has a referential relationship with each other. In the example of FIG. 4A, the Web page 134a has a link for referring to the Web page 138a. Further, the Web page 138b has a link for referring to the Web page 134b.

FIG. 4B is an explanatory view to explain another example of classification of information by the classification unit 130 according to the embodiment. On the left of FIG. 4B, an information set 112b including a service log acquired from a log server by the information acquisition unit 110 is shown. For example, it is assumed that the service log included in the information set 112b represents an action history such as content viewing or purchase of each user. The classification unit 130 checks a content name included in each entry of the service log against the “information element” defined by the information element data. Then, the classification unit 130 classifies information related to a content with a content name matching the “information element” into the node class and information related to a user who has viewed or purchased the content into the association class. For example, referring to the right of FIG. 4B, information 133 of the node class includes information related to three contents (“Item A”, “Item B” and “Item C”). Further, information of the association class includes information related to two users (“User U1” and “User U2”). Each user information has a referential relationship (viewing, purchase etc.) to each content information.

The classification unit 130 classifies each information included in the information set into information of the node class and information of the association class as described above, and outputs the information of the node class and the information of the association class to the evaluation unit 140.

### (Evaluation Unit)

The evaluation unit 140 evaluates a degree of association between information elements that respectively correspond to two or more information of the node class based on a referential relationship between the information of the node class and the information of the association class classified by the classification unit 130. Further, the evaluation unit 140 also determines a type of association between information elements that respectively correspond to two or more information of the node class based on the referential relationship.

A process of evaluating a degree of association by the evaluation unit 140 is broadly divided into two steps. A first step is counting of the number of references. A second step is calculation of a degree of association based on the counted number of references.

### (1) Counting of Number of References

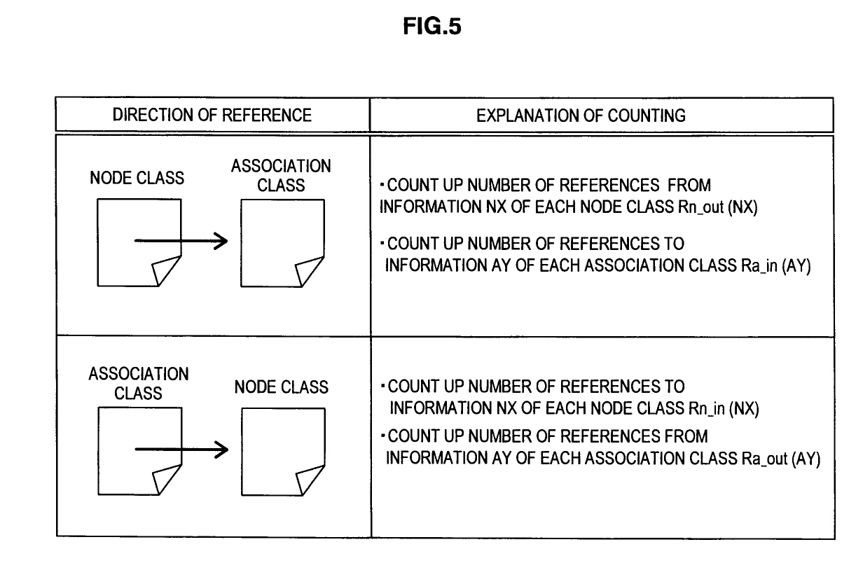

The evaluation unit 140 first counts the number of references from information of the node class to information of the association class and the number of references from information of the association class to information of the node class with respect to each information in the information set. FIG. 5 is an explanatory view to explain a basic rule for counting of the number of references by the evaluation unit 140 according to the embodiment. In the column on the left of FIG. 5, a reference from the node class to the association class and a reference from the association class to the node class are shown as references in two types of directions.

The reference from the node class to the association class is an outbound reference when focusing on information of the node class, and it is an inbound reference when focusing on information of the association class. When the evaluation unit 140 detects the reference from the node class to the association class in the information set, the evaluation unit 140 counts up the number of outbound references Rₙ_{_{—}}ₒᵤₜ (NX) about information NX of the node class and also counts up the number of inbound references Rₐ_{_{—}}ᵢₙ (AY) about information AY of the association class.

Further, the reference from the association class to the node class is an inbound reference when focusing on information of the node class, and it is an outbound reference when focusing on information of the association class. When the evaluation unit 140 detects the reference from the association class to the node class in the information set, the evaluation unit 140 counts up the number of inbound references Rₙ_{_{—}}ᵢₙ (NX) about information NX of the node class and also counts up the number of outbound references Rₐ_{_{—}}ₒᵤₜ (AY) about information AY of the association class.

Note that, when only a reference in one direction among the references in two types of directions shown in FIG. 5 exists, counting of a reference in either one direction may be omitted. For example, when only the reference from information of the association class to information of the node class exists as in the example shown in FIG. 4B, only the number of inbound references Rₙ_{_{—}}ᵢₙ (NX) about the information NX of the node class and the number of outbound references Rₐ_{_{—}}ₒᵤₜ (AY) about the information AY of the association class are counted.

According to the above-described rule, the evaluation unit 140 counts at least one of the number of references from information of the node class to information of the association class and the number of references from information of the association class to information of the node class with respect to each information in the information set.

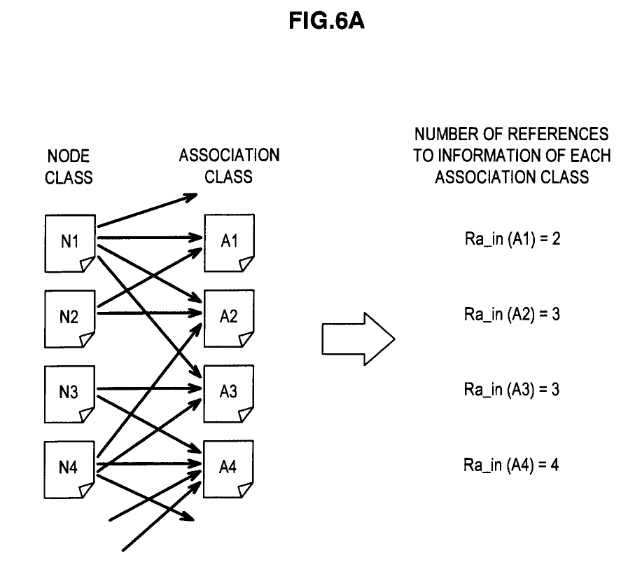

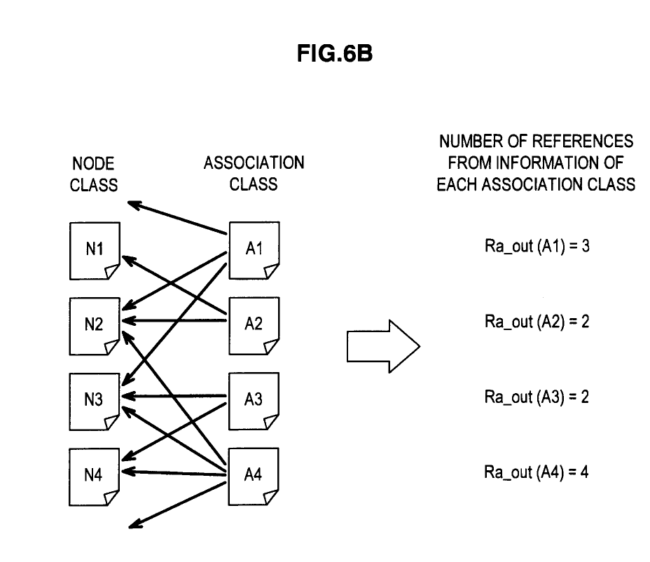

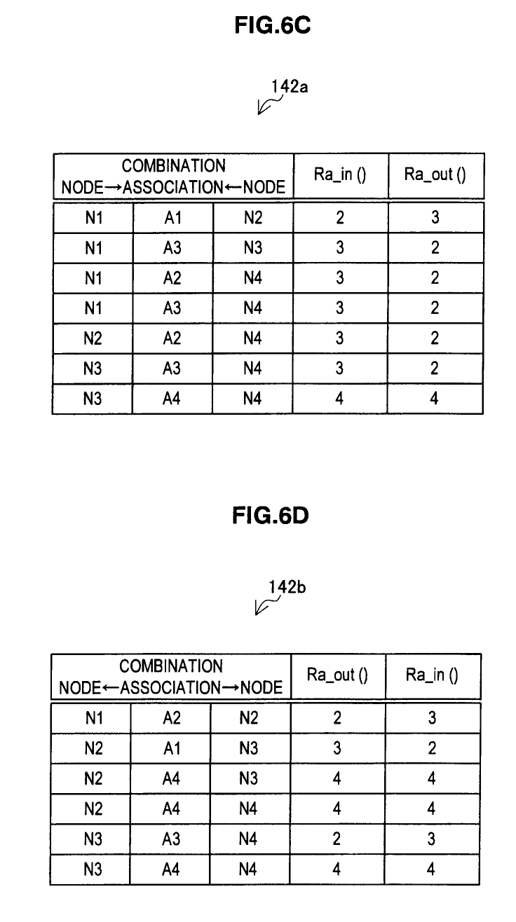

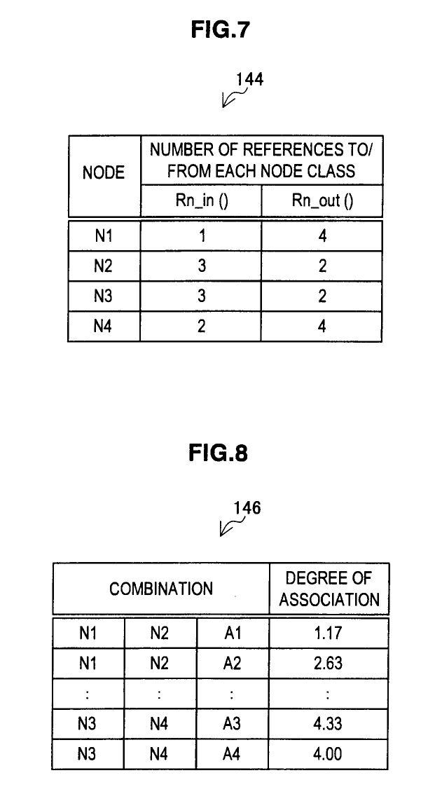

The counting of the number of references by the evaluation unit 140 is described hereinafter with reference to FIGS. 6A to 6D and FIG. 7 using specific examples.

First, as shown in FIG. 6A, the evaluation unit 140 counts the number of inbound references Rₐ_{_{—}}ᵢₙ( ) with respect to each information of the association class. For example, information A1 of the association class is referred to from information N1 and N2 of the node class, and Rₐ_{_{—}}ᵢₙ(A1)=2. Further, information A2 of the association class is referred to from information N1, N2 and N4 of the node class, and Rₐ_{_{—}}ᵢₙ(A2)=3. Furthermore, information A3 of the association class is referred to from information N1, N3 and N4 of the node class, and Rₐ_{_{—}}ᵢₙ(A3)=3. In addition, information A4 of the association class is referred to from information N3 and N4 of the node class and two other information of the node class, and Rₐ_{_{—}}ᵢₙ(A4)=4.

Further, as shown in FIG. 6B, the evaluation unit 140 counts the number of outbound references Rₐ_{_{—}}ₒᵤₜ( ) with respect to each information of the association class. For example, information A1 of the association class refers to information N2 and N3 of the node class and another information of the node class, and Rₐ_{_{—}}ₒᵤₜ(A1)=3. Further, information A2 of the association class refers to information N1 and N2 of the node class, and Rₐ_{_{—}}ₒᵤₜ(A2)=2. Furthermore, information A3 of the association class refers to information N3 and N4 of the node class, and Rₐ_{_{—}}ₒᵤₜ(A3)=2. In addition, information A4 of the association class refers to information N2, N3 and N4 of the node class and another information of the node class, and Rₐ_{_{—}}ₒᵤₜ(A4)=4.

Next, as shown in FIG. 6C, the evaluation unit 140 lists the number of inbound references Rₐ_{_{—}}ᵢₙ( ) and the number of outbound references Rₐ_{_{—}}ₒᵤₜ( ) of information of the association class on a table 142a for each combination of information of the node class that refer to common information of the association class and the common information of the association class. For example, in FIG. 6A, the information N1 and N2 of the node class refer to the common information A1 of the association class. Therefore, the table 142a contains entries Rₐ_{_{—}}ᵢₙ(A1)=2 and Rₐ_{_{—}}ₒᵤₜ(A1)=3 for the combination of the information N1, A1 and N2. Further, the information N1 and N3 of the node class refer to the common information A3 of the association class. Therefore, the table 142a contains entries Rₐ_{_{—}}ᵢₙ(A3)=3 and Rₐ_{_{—}}ₒᵤₜ(A3)=2 for the combination of the information N1, A3 and N3. In the same manner, the evaluation unit 140 lists numbers of references Rₐ_{_{—}}ᵢₙ( ) and Rₐ_{_{—}}ₒᵤₜ( ) of information of the association class for other combinations as well.

Further, as shown in FIG. 6D, the evaluation unit 140 lists the number of inbound references Rₐ_{_{—}}ᵢₙ( ) and the number of outbound references Rₐ_{_{—}}ₒᵤₜ( ) of information of the association class on a table 142b for each combination of information of the node class that are referred to from common information of the association class and the common information of the association class. For example, in FIG. 6B, the information N1 and N2 of the node class are referred to from the common information A2 of the association class. Therefore, the table 142b contains entries Rₐ_{_{—}}ₒᵤₜ(A2)=2 and Rₐ_{_{—}}ᵢₙ(A2)=3 for the combination of the information N1, A2 and N2. Further, the information N2 and N3 of the node class are referred to from the common information A1 of the association class. Therefore, the table 142b contains entries Rₐ_{_{—}}ₒᵤₜ(A1)=3 and Rₐ_{_{—}}ᵢₙ(A1)=2 for the combination of the information N2, A1 and N3. In the same manner, the evaluation unit 140 lists numbers of references Rₐ_{_{—}}ₒᵤₜ( ) and Rₐ_{_{—}}ᵢₙ( ) of information of the association class for other combinations as well.

Note that, when only a reference in one direction among the references in two types of directions shown in FIG. 5 exists, either one of the table 142a or the table 142b may not be generated. Further, in the following description, the number of inbound references in the table 142a is indicated by Rₐ₁_{_{—}}ᵢₙ( ) and the number of inbound references in the table 142b is indicated by Rₐ₂_{_{—}}ᵢₙ( ) thereby distinguishing between them. Further, the number of outbound references in the table 142a is indicated by Rₐ₁_{_{—}}ₒᵤₜ( ) and the number of outbound references in the table 142b is indicated by Rₐ₂_{_{—}}ₒᵤₜ( ), thereby distinguishing between them.

Then, as shown in FIG. 7, the evaluation unit 140 lists the number of inbound references Rₙ_{_{—}}ᵢₙ( ) and the number of outbound references Rₙ_{_{—}}ₒᵤₜ( ) of each information of the node class on a table 144. For example, referring to FIG. 7, the table 144 contains the total eight values of the numbers of inbound and outbound references for the information N1 to N4. Specifically, Rₙ_{_{—}}ᵢₙ(N1)=1, Rₙ_{_{—}}ₒᵤₜ(N1)=4, Rₙ_{_{—}}ᵢₙ(N2)=3, Rₙ_{_{—}}ₒᵤₜ(N2)=2, Rₙ_{_{—}}ᵢₙ(N3)=3, Rₙ_{_{—}}ₒᵤₜ(N3)=2, Rₙ_{_{—}}ᵢₙ(N4)=2, and Rₙ_{_{—}}ₒᵤₜ(N4)=4.

(2) Calculation of Degree of Association Based on those results of counting, the evaluation unit 140 calculates a degree of association between information elements that respectively correspond to two or more information of the node class. The evaluation unit 140 first calculates a degree of association between information elements with respect to each common information of the association class. Assume that a degree of association between information elements that respectively correspond to information Ni and Nj of the node class for common information Ak of the association class is DA(Ni, Nj, Ak), DA(Ni, Nj, Ak) may be calculated by the following expression, for example.

$$DA ( Ni , Nj , Ak ) = ( \frac{{R}_{n \_ in} ( Ni )}{{R}_{n \_ out} ( Ni )} + \frac{{R}_{n \_ in} ( Nj )}{{R}_{n \_ out} ( Nj )} ) ( {w}_{1} \frac{{R}_{a 1 \_ in} ( Ak )}{{R}_{a 1 \_ out} ( Ak )} + {w}_{2} \frac{{R}_{a 2 \_ in} ( Ak )}{{R}_{a 2 \_ out} ( Ak )} ) \qquad Expression ( 1 )$$

Note that values of weighting factors w₁ and w₂ in the expression (1) are previously set depending on to which of a reference to information of the association class and a reference from information of the association class greater importance is given. Further, when the combination of (Ni, Nj, Ak) does not exist in the table 142a, the expression (1) is calculated with the weighting factor w₁=0. Likewise, when the combination of (Ni, Nj, Ak) does not exist in the table 142b, the expression (1) is calculated with the weighting factor w₂=0.

A first component on the right-hand side of the expression (1) represents that a degree of association is calculated to be higher when two information of the node class do not much refer to other information and the two information of the node class are much referred to from other information. Further, a second component on the right-hand side of the expression (1) represents that a degree of association is calculated to be higher when common information of the association class does not much refer to other information and the common information of the association class is much referred to from other information. With such an expression of calculating a degree of association, it is possible to reduce an impact of link collection web pages on evaluation of a degree of association and enhance a contribution of a stronger referential relationship between Web pages (e.g. when corresponding to one of few links) to evaluation of a degree of association.

The above-described expression (1) is just an example. The evaluation unit 140 may calculate a degree of association DA(Ni, Nj, Ak) using the following expression (2) or (3), for example, instead of the expression (1). Further, the evaluation unit 140 may calculate a tentative degree of association according to any of the expressions (1) to (3) and then divide each calculated values by their maximum value to thereby calculate a normalized degree of association. Further, the evaluation unit 140 may use a deviation of a tentative degree of association as a definitive degree of association.

$$\begin{matrix}DA ( Ni , Nj , Ak ) = ( \frac{{R}_{n \_ in} ( Ni ) + {R}_{n \_ in} ( Nj )}{{R}_{n \_ out} ( Ni ) + {R}_{n \_ out} ( Nj )} ) ( {w}_{1} \frac{{R}_{a 1 \_ in} ( Ak )}{{R}_{a 1 \_ out} ( Ak )} + {w}_{2} \frac{{R}_{a 2 \_ in} ( Ak )}{{R}_{a 2 \_ out} ( Ak )} ) & Expression ( 2 ) \\ DA ( Ni , Nj , Ak ) = {w}_{1} \frac{{R}_{a 1 \_ in} ( Ak )}{{R}_{n \_ out} ( Ni ) + {R}_{n \_ out} ( Nj )} + {w}_{2} \frac{{R}_{a 2 \_ out} ( Ak )}{{R}_{n \_ in} ( Ni ) + {R}_{n \_ in} ( Nj )} & Expression ( 3 )\end{matrix}$$

FIG. 8 is an explanatory view showing an example of a degree of association for each information of an association class calculated based on a result of counting the number of references. The values of the degree of association shown in FIG. 8 are calculated according to the expression (1) based on the counting results shown in FIGS. 6C, 6D and 7. It is assumed that the values of the weighting factors w₁ and w₂ in the expression (1) are both set to 1.

In the example of FIG. 8, a degree of association between information elements that respectively correspond to the information N1 and N2 for the information A1 is calculated as DA(N1, N2, A1)=(¼+ 3/2)×(⅔+0)=1.17. Further, a degree of association between information elements that respectively correspond to the information N1 and N2 for the information A2 is calculated as DA(N1, N2, A2)=(¼+ 3/2)×(0+ 3/2)=2.63. In the same manner, the evaluation unit 140 calculates degrees of association for other combinations as well.

Note that, when only a reference in one direction among the references in two types of directions shown in FIG. 5 exists, other expressions can be used for calculation of a degree of association between information elements for each information of the association class. For example, when only a reference from information of the node class to information of the association class exists, any of the following expressions (4) to (6) (or a normalized value, a deviation of them etc.) may be used.

$$\begin{matrix}DA ( Ni , Nj , Ak ) = w \frac{1}{{R}_{a 1 \_ in} ( Ak ) ( {R}_{n \_ out} ( Ni ) + {R}_{n \_ ou t} ( Nj ) )} & Expression ( 4 ) \\ DA ( Ni , Nj , Ak ) = w \frac{1}{{R}_{a 1 \_ in} ( Ak )} \cdot ( \frac{1}{{R}_{n \_ out} ( Ni )} + \frac{1}{{R}_{n \_ out} ( Nj )} ) & Expression ( 5 ) \\ DA ( Ni , Nj , Ak ) = w \frac{1}{{R}_{a 1 \_ in} ( Ak )} & Expression ( 6 )\end{matrix}$$

As is understood from the explanation of FIG. 8, in this embodiment, a degree of association between information elements is calculated for each information of the association class having a referential relationship with two or more corresponding information of the node class. Accordingly, it can be considered that a plurality of types of association exist between one information element and another one information element, and a degree of association is calculated for each of the plurality of types of association. The type of association corresponds to a viewpoint of associating a concept indicated by a certain information element with a concept indicated by another information element. As a simple example, (a concept of) an actor A and (a concept of) an actor B can be associated by a viewpoint of a common work and also associated by a viewpoint of a common year of birth (e.g. 1930). The information processing device 100 according to the embodiment extracts such a plurality of types of association (viewpoints) from an information set which is represented as so-called collective intelligence and thereby obtains a type and a degree of association regarding association between concepts which are unexpected (surprising) for a user.

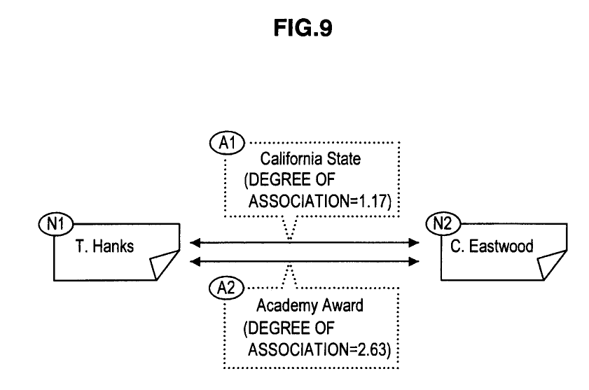

Thus, the evaluation unit 140 can determine a type of association (i.e. a viewpoint) between information elements respectively corresponding to two or more information of the node class based on the above-described referential relationship. FIG. 9 is an explanatory view showing an example of a type of association between information elements that can be determined by the evaluation unit 140 according to the embodiment. Referring to FIG. 9, the information N1 and N2 of the node class have a referential relationship with the common information A1 and A2 of the association class. The information N1 of the node class corresponds to the information element of a person “T. Hanks”. The information N2 of the node class corresponds to the information element of a person “C. Eastwood”. The evaluation unit 140 calculates a degree of association between the person “T. Hanks” and the person “C. Eastwood” for the information A1 of the association class as 1.17. Further, the evaluation unit 140 determines a type of the association from the information A1 of the association class. Specifically, when the information A1 of the association class is a Web page and the Web page has the headline “California State”, for example, “California State” can be determined as the type of the association. Further, a degree of association between the person “T. Hanks” and the person “C. Eastwood” for the information A2 of the association class is 2.63. When the information A2 of the association class is a Web page and the Web page has the headline “Academy Award”, for example, “Academy Award” can be determined as the type of the association. As another example, when information of the association class is user information in a service log, one of attribute values of the user information may be determined as the type of the association.

Further, the evaluation unit 140 calculates a degree of association between information elements for a plurality of information of the association class by integrating the degrees of association between information elements which are calculated for each common information of the association class. In the following description, a degree of association between information elements for a plurality of information of the association class is referred to as an integrated degree of association.

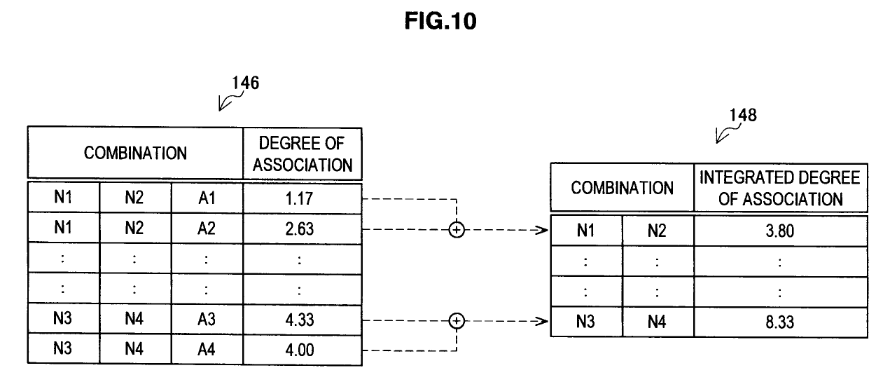

FIG. 10 is an explanatory view showing an example of an integrated degree of association calculated by the evaluation unit 140 according to the embodiment. The table 146 illustrated in FIG. 8 is shown on the left of FIG. 10. Further, a table 148 that stores an integrated degree of association that is calculated from numerical values contained in the table 146 is shown on the right of FIG. 10.

For example, an integrated degree of association between the information N1 and N2 of the node class is calculated as 3.80, which is the sum of the degree of association (=1.17) for the information A1 of the association class and the degree of association (=2.63) for the information A2 of the association class between the information N1 and N2 of the node class. Likewise, an integrated degree of association between the information N3 and N4 of the node class is calculated as 8.33. Note that the integrated degree of association may be normalized or calculated as a deviation just like the degree of association for each information of the association class.

The evaluation unit 140 outputs the degrees of association between information elements, the type of each association and the integrated degree of association which are calculated as above to the degree of association DB 150.

### (Degree of Association DB)

The degree of association DB 150 stores a result of the evaluation by the evaluation unit 140, i.e. the degrees of association between information elements, the type of each association and the integrated degree of association, by using a storage medium such as a hard disk or a semiconductor memory. Then, the degree of association DB 150 outputs the stored data in response to a request from the screen control unit 160, the recommendation unit 170 or the analysis unit 180, which are described later.

### [2-2. Navigation]

Navigation for a search of an information element by a user as an example of application of the degrees of association between information elements, the type of each association and the integrated degree of association which are stored in the degree of association DB 150 as a result of the evaluation by the evaluation unit 140 is described hereinafter. Among the components parts of the information processing device 100 shown in FIG. 2, the screen control unit 160 is mainly involved in the navigation according to the embodiment.

### (Screen Control Unit)

The screen control unit 160 creates an information element display screen that plays a role of so-called navigation for supporting a search of an information element by a user by using the degrees of association between information elements which are stored in the degree of association DB 150. Specifically, the screen control unit 160 first displays two information elements that are associated with each other so as to be adjacent to each other on the information element display screen. A user sequentially selects the information elements displayed on the information element display screen and thereby trace the information elements that are associated with one another (that have a certain degree of association in the degree of association DB 150).

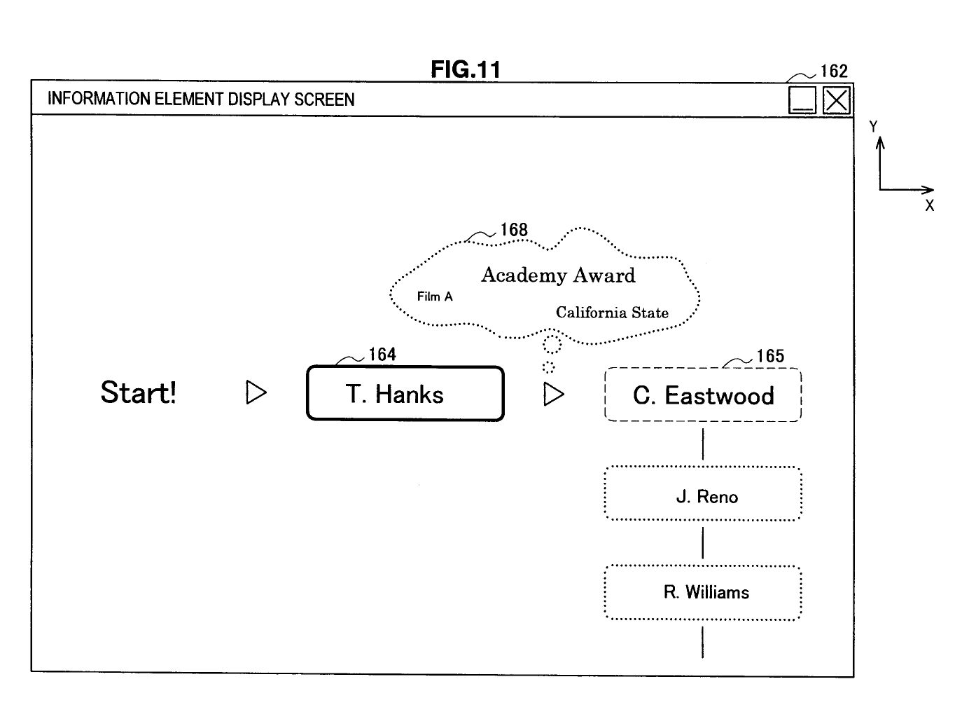

FIG. 11 is an explanatory view showing an information element display screen 162 as an example of the information element display screen created by the screen control unit 160 according to the embodiment.

In FIG. 11, a currently selected information element (which is referred to hereinafter as a latest selected element) 164 is shown at the center of the information element display screen 162. Further, an information element (which is referred to hereinafter as a selection candidate element) 165 that is associated with the latest selected element 164 is shown at the position adjacent to the latest selected element 164 in the X-direction of the screen. The selection candidate element 165 is an information element which is displayed adjacent to the latest selected element 164 in the state where the latest selected element 164 is selected and which a user can select next.

Further, the screen control unit 160 displays the type of association between the two information elements in close proximity to the latest selected element 164 and the selection candidate element 165 displayed adjacent to each other on the information element display screen 162. In the example of FIG. 11, an association display area 168 that displays three types of association is shown above the part between the latest selected element 164 and the selection candidate element 165. The types of association displayed in the association display area 168 may be highlighted according to the level of the degree of association of each type between the latest selected element 164 and the selection candidate element 165, for example. In the example of FIG. 11, as the type of association between “T. Hanks” and “C. Eastwood”, “Academy Award” is displayed at the largest size in the association display area 168. Further, “California State” and “Film A” are displayed as the types of association between “T. Hanks” and “C. Eastwood” in the association display area 168. The types of association displayed in the association display area 168 are selected according to the level of the degree of association in the degree of association DB 150 (e.g. the top 3 in the degree of association, the degree of association of 1.0 or higher etc.).

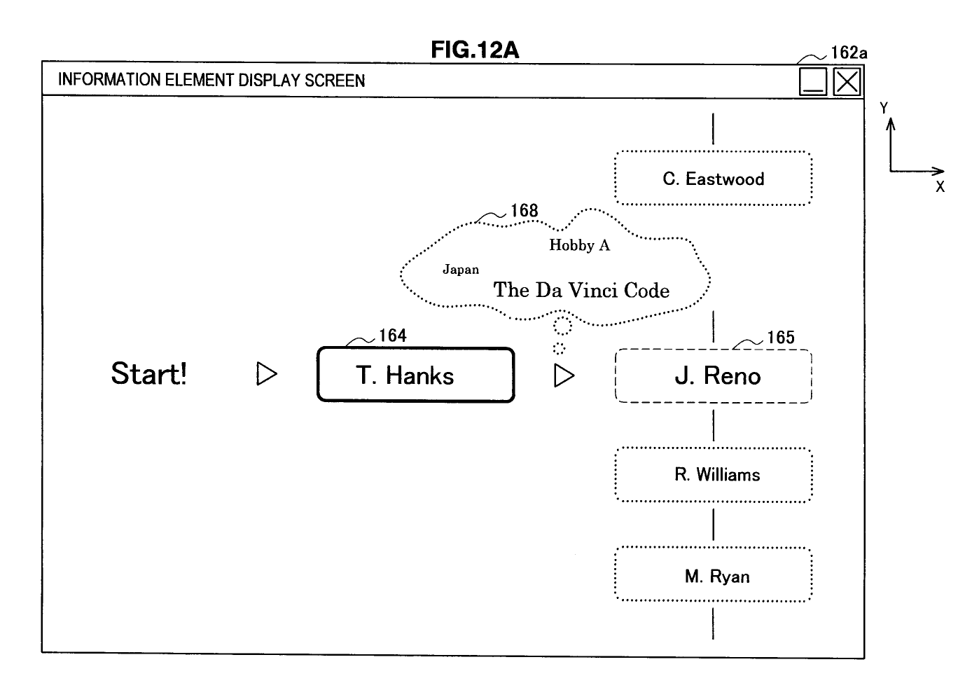

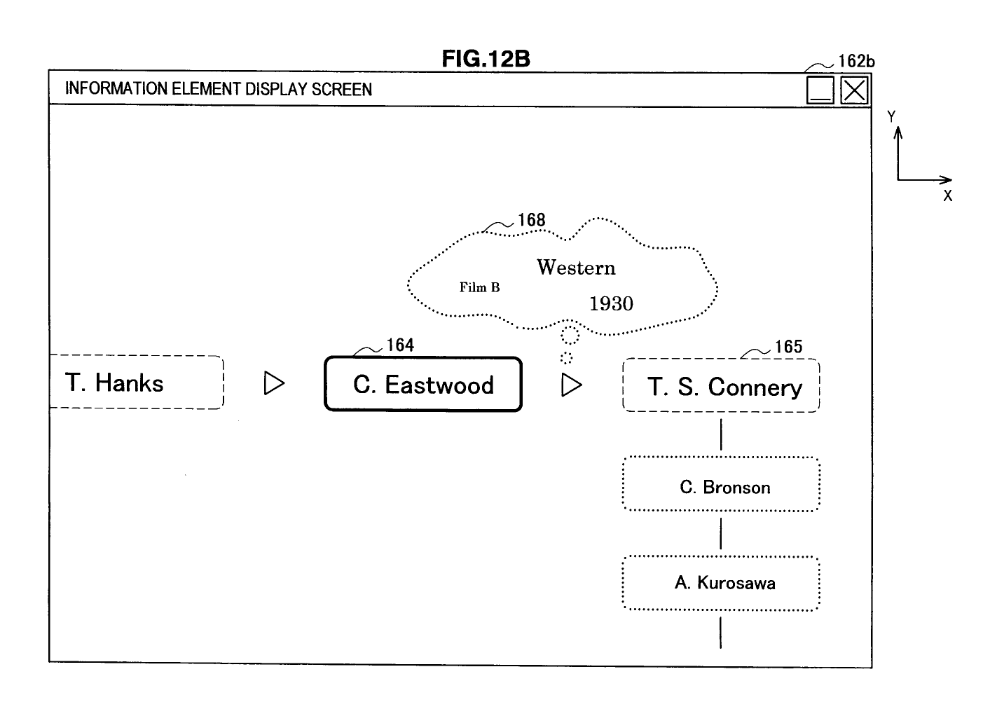

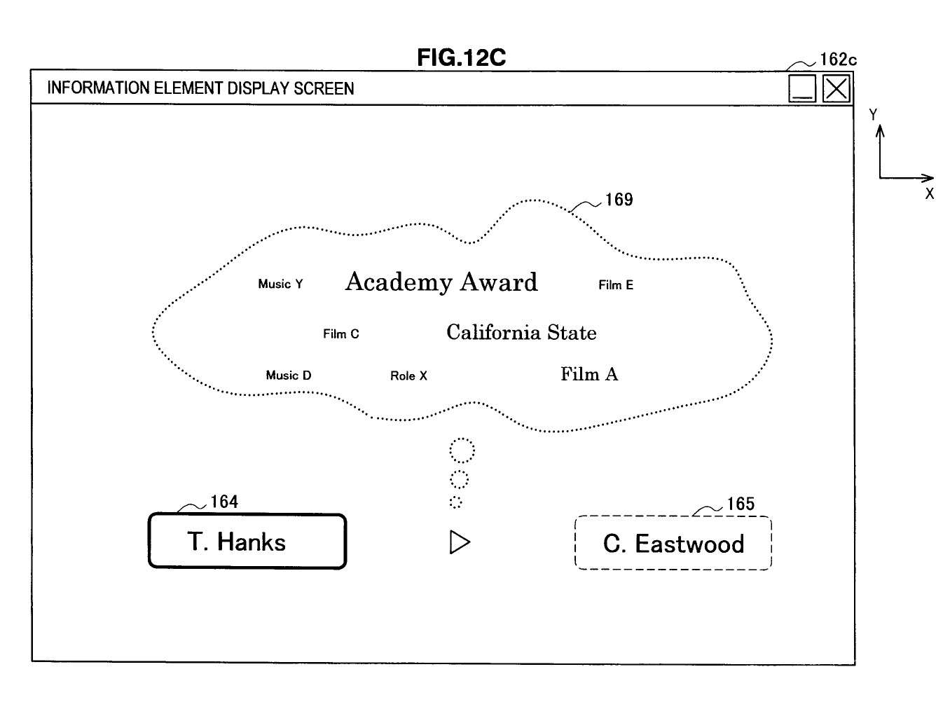

FIGS. 12A to 12C are explanatory views to explain a change in the display of the information element display screen 162 when any user input is detected in the terminal device 200 that displays the information element display screen 162 illustrated in FIG. 11 on its display.

For example, it is assumed that a user directs an upward movement by a user input (e.g. pressing of a “↑” button, an upward flick etc.) when the information element display screen 162 illustrated in FIG. 11 is displayed. Then, the screen changes to an information element display screen 162a shown in FIG. 12A. On the information element display screen 162a, “C. Eastwood” which has been the previous selection candidate element 165 moves in the Y-direction, and “J. Reno” which is the new selection candidate element 165 is displayed. Further, “The Da Vinci Code”, “Hobby A” and “Japan” are displayed in the association display area 168 as the types of association between “T. Hanks” and “J. Reno”.

Further, it is assumed that a user directs a rightward movement by a user input (e.g. pressing of a “→” button, a rightward flick etc.) when the information element display screen 162 illustrated in FIG. 11 is displayed. Then, the screen changes to an information element display screen 162b shown in FIG. 12B. On the information element display screen 162b, “T. Hanks” which has been the previous latest selected element 164 moves backward in the X-direction, and “C. Eastwood” which is the new latest selected element 164 is displayed. Further, the selection candidate element 165 is also changed to “T. S. Connery”. Furthermore, “Western”, “1930” and “Film B” are displayed in the association display area 168 as the types of association between “C. Eastwood” and “T. S. Connery”.

Furthermore, it is assumed that a user makes a user input such as pressing of an enter key or tapping of a given position on the screen when the information element display screen 162 illustrated in FIG. 11 is displayed. Then, the screen changes to an information element display screen 162c shown in FIG. 12C. On the information element display screen 162c, “T. Hanks” which is the latest selected element 164 and “C. Eastwood” which is the selection candidate element 165 at that point of time are zoomed up, and a detailed association display area 169 that displays details of association between those elements is shown. In the detailed association display area 169, a plurality of types of association (typically, types of association with lower degrees of association) which have not been displayed in the association display area 168 of the information element display screen 162 are additionally displayed. In the detailed association display area 169, values of the degrees of association may be further displayed. Note that, the information element display screen 162c can be changed back to the information element display screen 162 when a user presses the enter key, a cancel key or the like.

As described above, the screen control unit 160 sequentially arranges the information elements selected by a user in a first direction (e.g. the X-direction) on the information element display screen. The user can search the information elements through the tracing of the information elements associated with each other by movement or scrolling along the first direction. Further, the screen control unit 160 displays a plurality of information elements associated with the information element selected most recently by a user (i.e. the latest selected element) in a second direction (e.g. the Y-direction) different from the first direction. The user can select a new interested information element by moving or scrolling the information elements arranged in the second direction along the second direction. At that time, by checking the types of association displayed in the association display area, the user can grasp at what viewpoint the latest selected element and the selection candidate element are associated with each other and thereby understand the reason why the selection candidate element is displayed.

Such a user interface provides a user with a new way of information search based on mutual association of knowledge, which is different from the keyword search or the genre search. Further, because there is no need of a character input for information search, the user interface can be well-adopted in a terminal device without a keyboard, thereby improving the convenience of a user of such a terminal device.

Note that the information elements arranged in the second direction are information elements having association with the latest selected element in the degree of association DB 150. For example, the information elements may be arranged in the second direction in the order according to the level of the integrated degree of association with the latest selected element. Further, the information elements may be highlighted when the integrated degree of association is high.

Further, the screen control unit 160 may display only the information elements that belong to a specific category on the information element display screen. For example, by displaying only the information elements that belong to the category “person” on the information element display screen, the information element display screen can be used as a person search screen. Further, by displaying only the information elements that belong to the category “content” on the information element display screen, the information element display screen can be used as a content search screen. In this case, the screen control unit 160 may provide a user interface for switching the category of information elements to be displayed on the information element display screen.

### [2-3. Application to Recommendation]

Hereinafter, recommendation of an information element to a user as another example of application of the degrees of association between information elements, the type of each association and the integrated degree of association which are stored in the degree of association DB 150 as a result of the evaluation by the evaluation unit 140 is described. Among the components parts of the information processing device 100 shown in FIG. 2, the recommendation unit 170, the analysis unit 180 and the preference DB 190 are mainly involved in the recommendation according to the embodiment.

### (Recommendation Unit)

The recommendation unit 170 selects a content to be recommended to a user from contents that can be provided to the user by the information processing device 100 and displays information associated with the selected content on a screen created by the screen control unit 160.

### (1) Recommendation Using Association

The recommendation unit 170 may select a content to be recommended by using the degree of association between information elements or the type of association stored in the degree of association DB 150. For example, when a first content and a second content are viewed by a user, the recommendation unit 170 may select a content to be recommended according to the type of association between information elements that correspond to the first content and the second content.

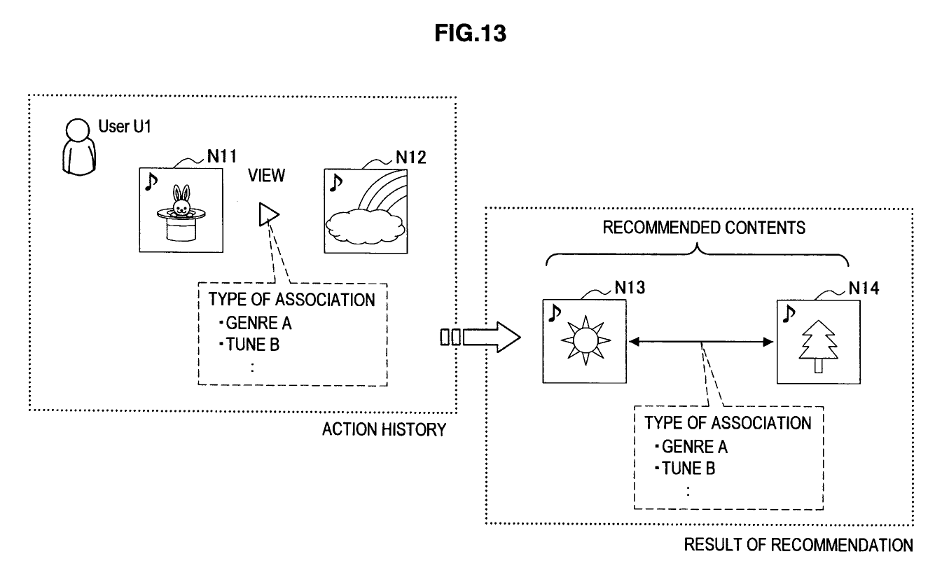

FIG. 13 is an explanatory view to explain an example of a recommendation process according to a type of association between information elements by the recommendation unit 170 according to the embodiment. In the example of FIG. 13, it is assumed that the information processing device 100 provides a service that a user can view information related to music contents and listen to or purchase a music content. It is further assumed that information elements that correspond to the music contents provided by the information processing device 100 are defined by information element data, and a degree of association between the information elements is evaluated by the evaluation unit 140.

Referring to the left of FIG. 13, an action history of a user U1 is shown. The action history indicates that the user U1 has viewed a first content N11 and then viewed a second content N12. Based on such an action history, the recommendation unit 170 acquires types of association between information elements that correspond to the first content N11 and the second content N 12 from the degree of association DB 150. For example, the types of association between information elements that correspond to the first content N11 and the second content N12 are “genre A”, “tune B” and so on. Then, the recommendation unit 170 selects third and fourth contents having the same or similar types of association. For example, a third content N13 and a fourth content N14 having the types of association of “genre A” and “tune B” can be selected by the recommendation unit 170. The recommendation unit 170 recommends the third content N13 and the fourth content N14 selected in this manner to a user on the screen which is output from the screen control unit 160 to the terminal device 200.

Note that the recommendation unit 170 may recommend a content to a user by using the information element display screen which is described in the previous section. For example, in the case where the information element display screen displays the information element that belongs to the category “content”, when any type of association displayed in the association display area is designated by a user, the recommendation unit 170 may select another content having the designated type of association and recommend the content to the user. Further, the recommendation unit 170 may automatically recommend a content having the same or similar type of association as the latest selected element and the selection candidate element to a user.

### (2) Analysis of User Preference

Most of general recommendation techniques make recommendation by using a user preference which is obtained by scoring (representing in numerical form) a preference of each user according to an action history of the user. For example, a recommendation algorithm called collaborative filtering compares a user preference between different users and sets a content which has been viewed by a user having the similar preference in the past as a content to be recommended. Further, a recommendation algorithm called content-based filtering compares a user preference and a content attribute that belong to a common vector space and sets a content close to a preference of a user as a content to be recommended. Thus, it is an important point for enhancing the effectiveness of recommendation to reflect an actual preference of a user in a score of a user preference as accurate as possible.

In light of the above, in this embodiment, the analysis unit 180 of the information processing device 100 represents a user preference in numerical form by using a result of the evaluation by the evaluation unit 140 stored in the degree of association DB 150, thereby obtaining an effective user preference. For example, when a series of information elements are viewed by a user, the analysis unit 180 determines a user preference by using a degree of association between information elements associated with each other which are included in the series of information elements.

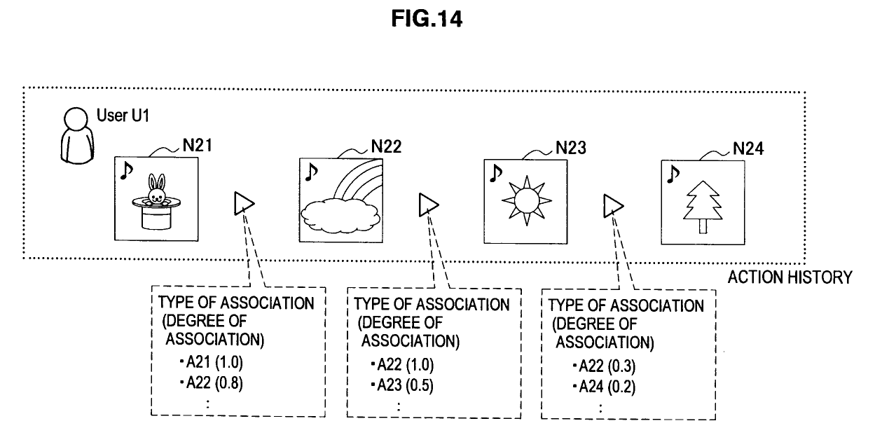

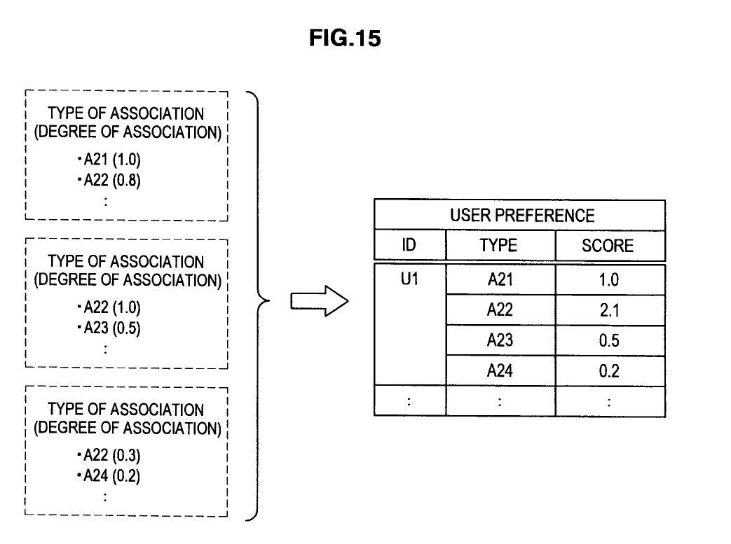

FIGS. 14 and 15 are explanatory views to explain an example of a user preference analysis process by the analysis unit 180 according to the embodiment. Referring to FIG. 14, another action history of the user U1 is shown. The action history indicates that the user U1 has sequentially selected (or viewed) contents N21, N22, N23 and N24 on the information element display screen or another screen. Based on such an action history, the analysis unit 180 acquires types of association and degrees of association between information elements that respectively correspond to the contents N21 and N22, the contents N22 and N23 and the contents N23 and N24 from the degree of association DB 150. For example, the types of association (the degrees of association) between information elements that correspond to the contents N21 and N22 are A21(1.0), A22(0.8) and so on.

Likewise, the types of association (the degrees of association) between information elements that correspond to the contents N22 and N23 are A22(1.0), A23(0.5) and so on. The types of association (the degrees of association) between information elements that correspond to the contents N23 and N24 are A22(0.3), A24(0.2) and so on.

Referring to FIG. 15, a user preference of the user U1 is determined by adding the degrees of association acquired by the analysis unit 180 in FIG. 14 together for the same type of association. Thus, the user preference of the user U1 forms a vector that contains the types of association A21, A22, A23 and A24 as elements. In the example of FIG. 14, the user preference of the user U1 is determined as (A21, A22, A23, A24)=(1.0, 2.1, 0.5, 0.2). Note that, the analysis unit 180 may assign weights to the degrees of association according to the recency of the action history and then add the degrees of association together for the same type of association, instead of simply adding the degrees of association together for the same type of association. The analysis unit 180 outputs the user preference determined in this manner to the preference DB 190.

### (Preference DB)

The preference DB 190 stores the user preference determined by the analysis unit 180 by using a storage medium such as a hard disk or a semiconductor memory. Then, the preference DB 190 outputs the stored user preference in response to a request from the recommendation unit 170.

Based on the user preferences accumulated in the preference DB 190, the recommendation unit 170 may select a content to be recommended to a user according to a technique such as the known collaborative filtering or content-based filtering, for example. In this case also, because a content is selected based on the user preference determined by the analysis unit 180 using the above-described degrees of association, it is possible to effectively recommend a content which is difficult for a user to expect to the user. Note that because a dimension of a vector space in which the user preference is represented in numerical form is not restricted in advance, the user preference determined by the analysis unit 180 can be a sparse vector that has a value for only limited elements in a vector space with an extremely high dimension. In this case, it is preferred to compress the vector by using a known technique such as PLSA (Probabilistic Latent Semantic Analysis) or LDA (Latent Dirichlet Allocation) and then determine a degree of similarity between user preferences or between a user preference and a content attribute.

### (3) Presentation of Reason for Recommendation

Further, according to the embodiment, the recommendation unit 170 can present a reason for recommendation of a content to a user according to a type of association between an information element corresponding to a content to be recommended and an information element as a basis of selection of the content.

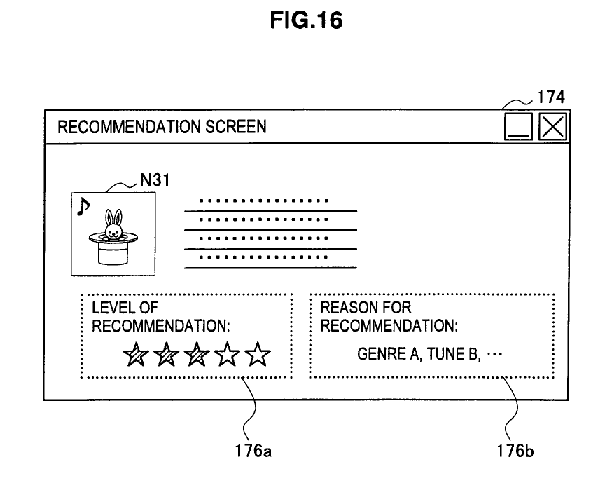

FIG. 16 is an explanatory view showing a recommendation screen 174 as an example of a screen on which a reason for recommendation is presented by the recommendation unit 170 according to the embodiment. Referring to FIG. 16, on the recommendation screen 174, a content N31 is recommended. Further, at the bottom of the recommendation screen 174, a recommendation level display field 176a and a recommendation reason display field 176b are placed. It is assumed that the content N31 is a content that is selected by the recommendation unit 170 based on the information element which has been viewed by a user in the past, for example. In this case, the recommendation unit 170 can acquire an integrated degree of association between an information element corresponding to the content N31 and the information element viewed in the past from the degree of association DB 150 and set a recommendation level of the recommendation level display field 176a according to the integrated degree of association. For example, when the integrated degree of association is high, the recommendation level can be set high. Note that, when the integrated degree of association acquired from the degree of association DB 150 falls below a predetermined threshold, the recommendation unit 170 may change a content to be recommended. Further, the recommendation unit 170 can acquire a type of association between an information element corresponding to the content N31 and the information element viewed in the past from the degree of association DB 150 and present the type of association as a reason for recommendation in the recommendation reason display field 176b.

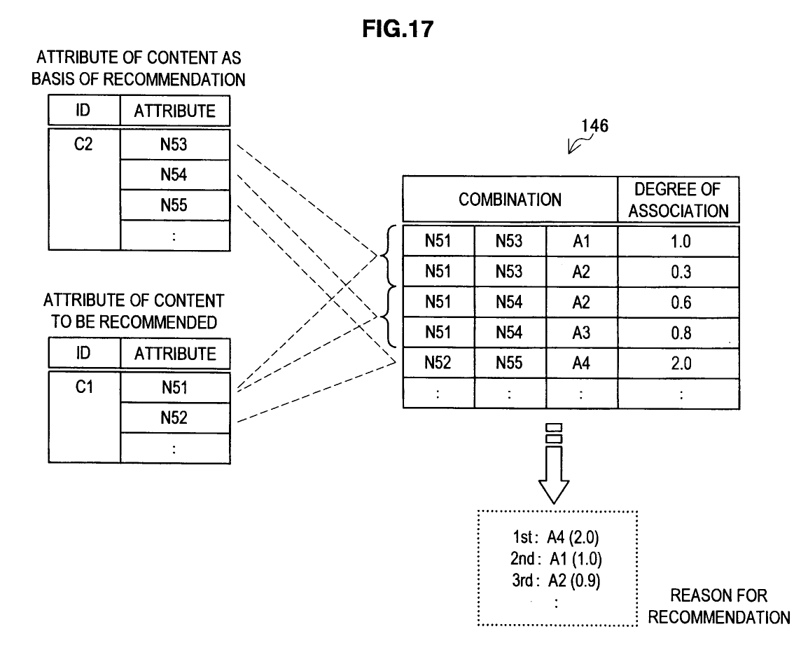

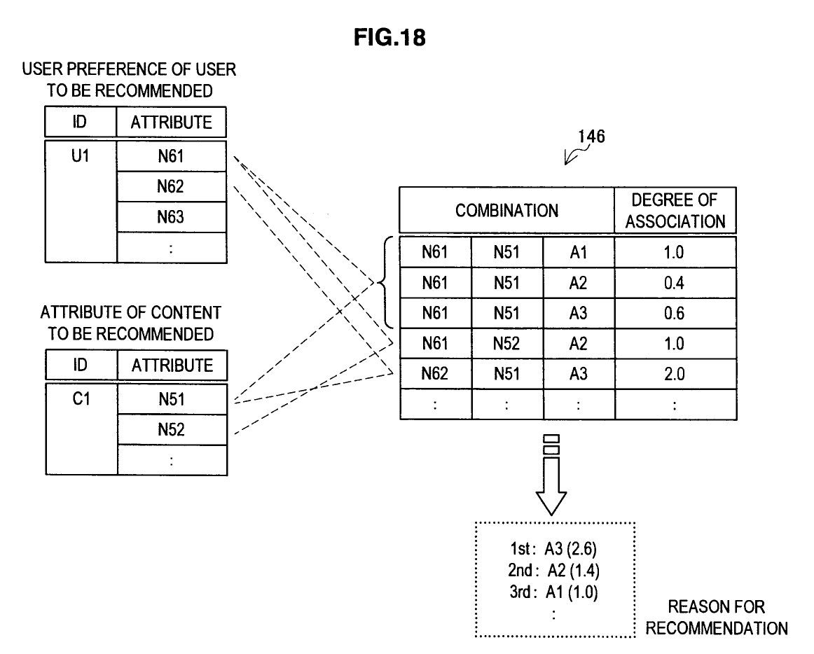

Note that a process of determining a reason for recommendation by the recommendation unit 170 is not limited to the above example. FIGS. 17 and 18 respectively show other examples of the process of determining a reason for recommendation by the recommendation unit 170.

FIG. 17 is an explanatory view to explain a first alternative example of the process of determining a reason for recommendation by the recommendation unit 170. It is assumed in this example that a content that is handled by a service provided from the information processing device 100 has an attribute corresponding to one or more information element of a plurality of information elements defined by information element definition data. It is further assumed that the recommendation unit 170 selects a content to be recommended to a user according to a content included in an action history of the user by using a technique such as the content-based filtering, for example.

In this case, the recommendation unit 170 determines a reason for recommendation according to a type of association between an information element corresponding to an attribute of the selected content to be recommended and another information element corresponding to an attribute of the content used as a basis of recommendation. In the example of FIG. 17, a content C1 to be recommended has attributes N51 and N52. Further, a content C2 as a basis of recommendation has attributes N53, N54 and N55. Further, a degree of association for each type of association between information elements corresponding to the attributes of those contents is stored in the table 146 of the degree of association DB 150. The recommendation unit 170 acquires the degree of association for each type of association from the table 146 and determines the type of association with a high degree of association as a reason for recommendation to be presented to a user. In the example of FIG. 17, because a type of association A4 between an information element corresponding to the attribute N52 of the content C1 and an information element corresponding to the attribute N55 of the content C2 indicates the highest degree of association 2.0, the type of association A4 is selected as a first reason for recommendation. Further, the type of association A1 is determined as a second reason for recommendation, and the type of association A2 is determined as a third reason for recommendation according to the level of the degree of association.

FIG. 18 is an explanatory view to explain a second alternative example of the process of determining a reason for recommendation by the recommendation unit 170. It is assumed in this example that a user preference of a user who uses a service provided from the information processing device 100 also has an attribute corresponding to one or more information element of a plurality of information elements defined by information element definition data.

In this case, the recommendation unit 170 determines a reason for recommendation according to a type of association between an information element corresponding to an attribute of the selected content to be recommended and another information element corresponding to an attribute of the user preference of the user to be recommended. In the example of FIG. 18, a content C1 to be recommended has attributes N51 and N52. Further, a user preference of the user U1 to be recommended has attributes N61, N62 and N63. Further, a degree of association for each type of association between information elements corresponding to the attribute of the content and the attribute of the user preference is stored in the table 146 of the degree of association DB 150. The recommendation unit 170 acquires the degree of association for each type of association from the table 146 and determines the type of association with a high degree of association as a reason for recommendation to be presented to a user. In the example of FIG. 18, because the sum (0.6+2.0=2.6) of the degrees of association for the type of association A3 is the highest, the type of association A3 is selected as a first reason for recommendation. Further, the type of association A2 is determined as a second reason for recommendation, and the type of association A1 is determined as a third reason for recommendation according to the level of the degree of association.

The recommendation unit 170 presents the reason for recommendation determined in this manner to a user on the recommendation screen 174 described with reference to FIG. 16 or another screen. The user can thereby know why the information processing device 100 recommends the content. As a result, even when an unexpected content is recommended, it is possible to convince a user about a reason for the recommendation, and the user can more easily decide an action (viewing, purchase, ignore etc.) for the recommended content.

### 3. Other Application Examples

### 3-1. Playback of Music

The degree of association between information elements and the type of association evaluated by the information processing device 100 described above can be used for various applications. As a first example, application to playback of music is described hereinbelow.

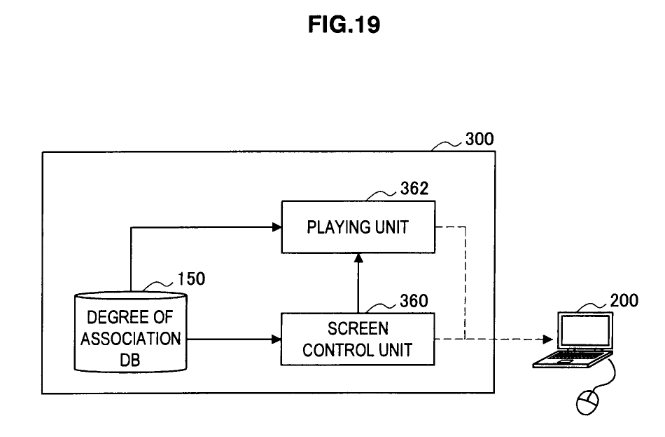

FIG. 19 is a block diagram showing an example of a configuration of an information processing device 300 according to a first application example. Referring to FIG. 19, the information processing device 300 includes a degree of association DB 150, a screen control unit 360 and a playing unit 362. It is assumed, for example, that degrees of association and types of association which are evaluated for information elements corresponding to music contents are stored in the degree of association DB 150.

### (Screen Control Unit)

The screen control unit 360 creates an information element display screen for supporting a search of a music content by a user by using the degrees of association between information elements stored in the degree of association DB 150. The information element display screen created by the screen control unit 360 may be a screen similar to the information element display screen 162 described earlier with reference to FIG. 11. However, the information element display screen displays information elements corresponding to music contents.

### (Playing Unit)

The playing unit 362 plays a music content selected by a user, i.e. a music content shown as the latest selected element, on the information element display screen. For example, when a user selects a series of music contents by operating a user interface of the terminal device 200, the playing unit 362 may sequentially play the series of music contents. By such a method of playing music contents, a user can enjoy music like channel zapping by sequentially selecting the music contents associated with one another. Because the association between the music contents is extracted from an information set which corresponds to so-called collective intelligence, an advantage such as an increase in the possibility that a user encounters a surprising (and convincing) music content.

Further, the playing unit 362 may automatically create a playlist of music contents by using the degrees of association between information elements stored in the degree of association DB 150 and sequentially play the music contents according to the playlist. In this case also, an advantage that a music content to be played can be both surprising and convincing is obtained.

### 3-2. Use of Positional Information

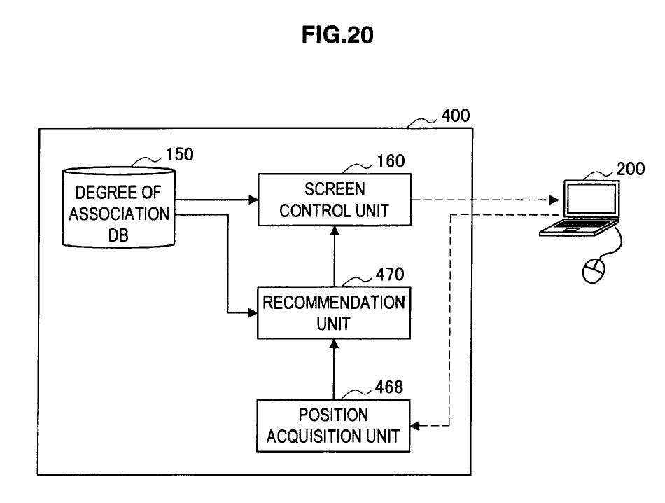

FIG. 20 is a block diagram showing an example of a configuration of an information processing device 400 according to a second application example. Referring to FIG. 20, the information processing device 400 includes a degree of association DB 150, a screen control unit 160, a position acquisition unit 468, and a recommendation unit 470. It is assumed that degrees of association and types of association which are evaluated for an information element corresponding to a position (latitude and longitude) on the globe or a place name and an information element corresponding to a given content are stored in the degree of association DB 150. The degree of association related to the information element corresponding to a position on the globe can be obtained by setting a Web page (e.g. a homepage of a store etc.) that is linked with a specific location in a geographical information Web site as a target for evaluation of a degree of association.

### (Position Acquisition Unit)

The position acquisition unit 468 acquires positional data of the terminal device 200 which is obtained by the terminal device 200 using GPS from the terminal device 200. Then, the position acquisition unit 468 outputs the acquired positional data to the recommendation unit 470.

### (Recommendation Unit)

The recommendation unit 470 selects a content to be recommended to a user from contents that can be provided to the user by the information processing device 400 and displays information associated with the selected content on a screen created by the screen control unit 160. At this time, the recommendation unit 470 selects a content having association with the positional data (or a place name corresponding to the positional data) supplied from the position acquisition unit 468 in the degree of association DB 150 as a content to be recommended. By such a recommendation method, when a user travels bringing the terminal device 200, for example, a content corresponding to a position of the user is recommended. Because the content recommended in this manner is selected based on a degree of association extracted from an information set which corresponds to so-called collective intelligence, it can be a surprising (and convincing) content for a user.

Note that a playing unit may be added to the information processing device 400, so that a music content selected according to a position of a user is played by the playing unit. It is thereby possible to automatically play the music content with a high degree of association with the position of the user.

### 4. Hardware Configuration

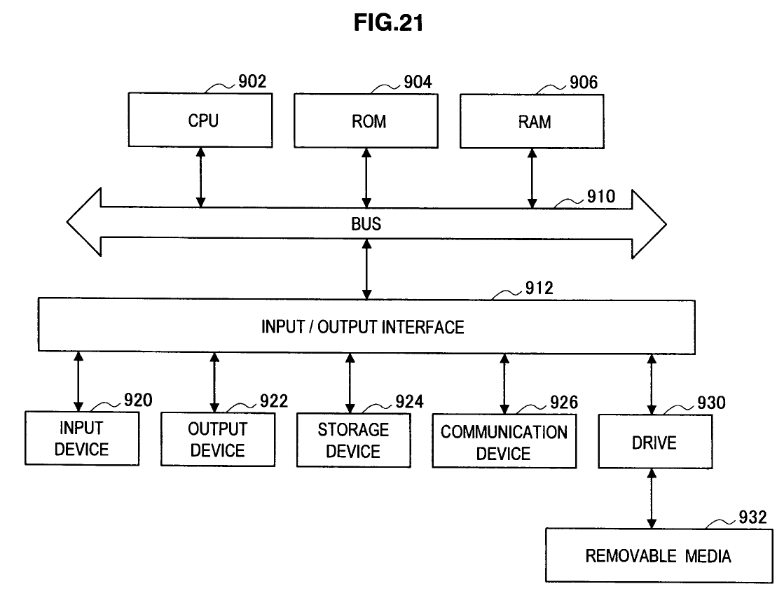

Each process by the information processing device 100, 300 and 400 described above can be implemented as software executable on a general-purpose computer shown in FIG. 21, for example. In FIG. 21, a CPU (Central Processing Unit) 902 controls the overall operation of the general-purpose computer. In a ROM (Read Only Memory) 904, a program or data describing each process is stored. In a RAM (Random Access Memory) 906, a program, data or the like to be used by the CPU 902 at the time of executing the process is temporarily stored.

The CPU 902, the ROM 904 and the RAM 906 are connected to one another through a bus 910. Further, an input/output interface 912 is connected to the bus 910. The input/output interface 912 is an interface for connecting the CPU 902, the ROM 904 and the RAM 906 with an input device 920, an output device 922, a storage device 924, a communication device 926 and a drive 930.

The input device 920 receives an instruction or information input from a user through an input device such as a button, a switch, a lever, a mouse or a keyboard, for example. The output device 922 outputs information to a user through a display device such as a CRT (Cathode Ray Tube), a liquid crystal display or an OLED (Organic Light Emitting Diode) or an audio output device such as a speaker, for example.

The storage device 924 is composed of a hard disk drive, a semiconductor memory or the like, for example, and stores programs, data and so on. The communication device 926 performs a communication process through a communication network. The drive 930 is mounted on the general-purpose computer according to need, and a removable medium 932 is loaded to the drive 930, for example.

### 5. Summary

One embodiment of the present invention and its alternative examples are described above with reference to FIGS. 1 to 21. According to the embodiment, a degree of association between information elements is evaluated based on a referential relationship between information of a node class corresponding to an information element as a target of information search or recommendation and information of an association class that is likely to connect two or more information elements. It is thereby possible to automatically evaluate association between various information elements such as a content like a person, music or a video or a position on the globe with respect to a variety of viewpoints described in collective intelligence. It is then possible to utilize degrees of association and types of association that are evaluated with respect to such a variety of viewpoints for information search or recommendation.

Further, the information element display screen according to the embodiment provides a novel user interface on the basis of mutual association of knowledge, which is different from the keyword search or the genre search. Such a user interface enables a user to trace various information elements by selecting an information element or a type of association interested by the user. Further, because the user interface can be adopted in a terminal device without a keyboard, it is possible to improve the convenience of a user of such a terminal device.

Furthermore, because the recommendation unit according to the embodiment recommends a content according to degrees of association between information elements described above, a user can find a content recommended based on a variety of viewpoints described in collective intelligence. Because a reason for recommendation can be presented at the same time, the content to be recommended can be both surprising and convincing. Further, with the analysis unit according to the embodiment, it is possible to obtain a user preference that accurately reflects an actual preference of a user based on a variety of viewpoints described in collective intelligence.

Although preferred embodiments of the present invention are described in detail above with reference to the appended drawings, the present invention is not limited thereto. It should be understood by those skilled in the art that various modifications, combinations, sub-combinations and alterations may occur depending on design requirements and other factors insofar as they are within the scope of the appended claims or the equivalents thereof.

The present application contains subject matter related to that disclosed in Japanese Priority Patent Application JP 2009-296065 filed in the Japan Patent Office on Dec. 25, 2009, the entire content of which is hereby incorporated by reference.

What is claimed is:

1. An information processing device comprising:
a storage unit that stores information element data defining a plurality of information elements;
an information acquisition unit that acquires an information set having a referential relationship with each other from an information source accessible through a communication network;
a classification unit that classifies information included in the information set acquired by the information acquisition unit into information of a first class corresponding to an information element defined by the information element data and information of a second class other than the information of the first class; and
an evaluation unit that evaluates a degree of association between information elements respectively corresponding to two or more information of the first class based on a referential relationship between the information of the first class and the information of the second class in the information set.

2. The information processing device according to claim 1, wherein
the evaluation unit further determines a type of association between the information elements respectively corresponding to two or more information of the first class based on the referential relationship between the information of the first class and the information of the second class in the information set.

3. The information processing device according to claim 2, wherein
the evaluation unit counts at least one of the number of references from the information of the first class to the information of the second class and the number of references from the information of the second class to the information of the first class with respect to each information in the information set, and calculates the degree of association between the information elements respectively corresponding to two or more information of the first class referring to common information of the second class or referred to from common information of the second class based on the number of references counted for the common second class.

4. The information processing device according to claim 3, wherein
the evaluation unit determines a type of association between the information elements respectively corresponding to the two or more information of the first class from the common information of the second class.

5. The information processing device according to claim 1, further comprising:
a screen control unit that outputs an information element display screen displaying two information elements associated with each other in a result of evaluation by the evaluation unit so as to be adjacent to each other.

6. The information processing device according to claim 5, wherein
the information element display screen is a screen where, in a state where one information element is selected, another information element displayed adjacent to the selected information element is selectable by a user.

7. The information processing device according to claim 6, wherein
the screen control unit sequentially arranges information elements selected by a user in a first direction and arranges a plurality of information elements associated with an information element selected most recently by a user in a second direction different from the first direction on the information element display screen, and
each information element arranged in the second direction is selectable by a user.

8. The information processing device according to claim 5, wherein
the screen control unit displays, in close proximity to the two information elements displayed adjacent to each other, a type of association between the two information elements on the information element display screen.

9. The information processing device according to claim 5, wherein
the screen control unit only displays information elements belonging to a given category among information elements having a certain degree of association in a result of evaluation by the evaluation unit on the information element display screen.

10. The information processing device according to claim 2, further comprising:
a recommendation unit that, when a first content and a second content are viewed by a user, recommends another content selected according to a type of association between information elements corresponding to the first content and the second content to the user.

11. The information processing device according to claim 6, further comprising:
an analysis unit that, when a series of information elements are viewed by a user, determines a preference of the user by using a degree of association between information elements associated with each other included in the series of information elements.

12. The information processing device according to claim 11, further comprising:
a recommendation unit that recommends a content selected based on a preference of a user determined by the analysis unit to the user.

13. The information processing device according to claim 2, further comprising:
a recommendation unit that recommends a content selected based on an information element viewed by a user to the user and presents a reason for recommendation of the content to the user according to a type of association between an information element corresponding to the content and an information element as a basis of selection of the content.

14. The information processing device according to claim 2, further comprising:
a recommendation unit that recommends a content selected according to an action history of a user from contents having an attribute corresponding to one or more information element among the plurality of information elements to the user and presents a reason for recommendation of the selected content to the user according to a type of association between an information element corresponding to an attribute of the selected content and another information element.

15. The information processing device according to claim 14, wherein
said another information element is an information element corresponding to an attribute of another content as a basis of selection of the content.

16. The information processing device according to claim 14, wherein
said another information element is an information element corresponding to an attribute of a user preference of the user.

17. The information processing device according to claim 1, wherein
the plurality of information elements defined by the information element data include an information element corresponding to a music content, and
the information processing device further comprises a playing unit that sequentially plays music contents corresponding to information elements associated with each other in a result of evaluation by the evaluation unit.

18. A method of evaluating a degree of association between information elements by using an information processing device including a storage unit that stores information element data defining a plurality of information elements, the method comprising the steps of:
acquiring an information set having a referential relationship with each other from an information source accessible through a communication network;
classifying information included in the information set acquired from the information source into information of a first class corresponding to an information element defined by the information element data and information of a second class other than the information of the first class; and
evaluating a degree of association between information elements respectively corresponding to two or more information of the first class based on a referential relationship between the information of the first class and the information of the second class in the information set.

19. A program causing a computer controlling an information processing device including a storage unit that stores information element data defining a plurality of information elements to function as a device comprising:
an information acquisition unit that acquires an information set having a referential relationship with each other from an information source accessible through a communication network;
a classification unit that classifies information included in the information set acquired by the information acquisition unit into information of a first class corresponding to an information element defined by the information element data and information of a second class other than the information of the first class; and
an evaluation unit that evaluates a degree of association between information elements respectively corresponding to two or more information of the first class based on a referential relationship between the information of the first class and the information of the second class in the information set.
